(19) United States
(12) Patent Application Publication
(10) Pub. No.: US 2010/0096786 A1
(43) Pub. Date: Apr. 22, 2010

(54) Air Spring

(75) Inventors: Ulrich ORLAMÜNDER, Gehrden (DE); Matthias MÖRITZ, Neustadt (DE)

Correspondence Address: LERNER GREENBERG STEMER LLP, P O BOX 2480, HOLLYWOOD, FL, 33022-2480, US

(73) Assignee: CONTINENTAL AKTIENGESELLSCHAFT, Hannover (DE)

(21) Appl. No.: 12/641,748

(22) Filed: Dec. 18, 2009

Related U.S. Application Data
(63) Continuation of application No. PCT/EP2008/057994, filed on Jun. 24, 2008.

(30) Foreign Application Priority Data
Jul. 24, 2007 (DE) 10 2007 034 362.2

(51) Int. Cl. F16F 9/05

(52) U.S. Cl. 267/64.27

(57) ABSTRACT

An air spring for a vehicle suspension, in which air spring the bellows is fastened by way of deformable annular components to the periphery of connection parts. The annular component is fastened at one end of the bellows, to the outer periphery of the connection part in axially spaced-apart clamping regions so as to form an encircling cavity, The annular component, on its outer side, is formed with a rolling contour for the bellows.

### CROSS-REFERENCE TO RELATED APPLICATION

This application is a continuation, under 35 U.S.C. §120, of copending international application PCT/EP2008/057994, filed Jun. 24, 2008, which designated the United States; this application also claims the priority, under 35 U.S.C. §119, of German patent application No. DE 10 2007 034 362.2, filed Jul. 24, 2007; the prior applications are herewith incorporated by reference in their entirety.

### BACKGROUND OF THE INVENTION

### Field of the Invention

The invention relates to an air spring for vehicle running gear. The air spring has at least one working space filled with compressed air, which is delimited at least partially by a bellows that rolls at least partially on rolling-contact contours, forming at least one rolling fold as it does so, and, at its ends, is fastened by way of deformable annular components to the periphery of connection parts, generally by clamping and/or form-locking engagement.

A large number of different fastening means for bellows are known. In general, use is made of clamping means that act on the periphery of the bellows, or of clamping rings which are placed around the bellows and clamp the wall of the bellows firmly on the surface of the respective connection part, i.e. on the air spring cover or on the rolling-contact plunger. To improve the clamping effect, the clamping rings or the ends of the bellows can have special designs of profile.

Fastening means in the form of beads are also known and, in this case, the bellows can be provided, where appropriate, with a core wire at the end and/or with reinforced thickened portions, which are clasped by the beaded edge after the connection has been produced.

German patent DE 103 54 574 B3 discloses an air spring with a tubular bellows, in which the ends of the bellows are clamped onto a fastening part/connection part with the aid of a clamping ring. On the periphery, in the fastening region provided, the respective fastening part has a profile which is formed in cross section by grooves and projecting lugs and into which the end of the bellows can be pressed and formed with the aid of the clamping rings which surround it on the outer side. The disadvantage with this design is, on the one hand, the extensive processing required to profile parts of the outer surface of the connection parts. On the other hand, the clamping regions on the connection part have to be made in such a way that the rolling of the bellows or fold in the bellows on the rolling-contact contour on the outer side of the connection part is not hindered.

### SUMMARY OF THE INVENTION

It is accordingly an object of the invention to provide an air spring which overcomes the above-mentioned disadvantages of the heretofore-known devices and methods of this general type and which provides for an improved connection between the air spring bellows and connection parts by enabling reliable sealing, production in as simple a manner as possible and integration of functions, hence ultimately simplifying the air spring overall.

With the foregoing and other objects in view there is provided, in accordance with the invention, an air spring for a vehicle chassis, comprising:

a rolling bellows attached to, and extending between, connecting parts, said rolling bellows enclosing at least one working space filled with compressed air;

said rolling bellows having ends connected, by way of deformable annular components, to respective peripheries of said connecting parts;

at least one of said annular components, at one end of said bellows, having a first end fastened at a first clamping region to an outer periphery of the associated said connection part and a second end fastened at a second clamping region, axially spaced apart from said first clamping region, and enclosing an encircling cavity;

said at least one annular component having an exterior rolling-contact contour, and said rolling bellows being fastened to a periphery of the associated said connection part by way of one of said first and second clamping regions; and

said rolling bellows being disposed to roll, at least partially, on said rolling-contact contour formed by said at least one annular component while forming at least one rolling fold.

In other words, the objects of the invention are achieved in that, at at least one end of the bellows, the annular component is fastened to the outer periphery of the associated connection part in axially spaced clamping regions, thereby forming an encircling cavity, and is designed on its outer side as a rolling-contact contour for the bellows, the bellows in turn being fastened to the periphery of the associated connection part by means of one of the clamping regions.

As a result, all that is required is to shape the annular component as a rolling-contact contour, and this can be accomplished in a significantly simpler and cheaper way by rollforming or pressing methods, for example, than by shaping the compact connection part, by corresponding shaping of the spring plunger in a process that involves machining, for example. Moreover, there is no need for a separate clamping ring to fasten the air spring bellows.

An advantageous development consists in that the axially spaced clamping regions are fastened in a sealing manner to the outer periphery of the associated connection part, and the encircling cavity is fluidically connected to the working space. This is a very simple way of bringing about an enlargement of the working space and hence the possibility of influencing the spring characteristic.

Another embodiment, which is advantageous owing to the simplicity of its manufacture, consists in that the encircling cavity is connected to the working space by bores that are formed in the region of the annular component and on the periphery of the connection part.

In accordance with an advantageous feature of the invention, the annular component is provided in the region of the rolling-contact contour with bores which are covered in a sealing manner with flexible materials on the outer side of the annular component. This opens up the possibility of the rolling-contact contour changing as a function of the pressure in the working space, namely by the mouths of the bores, which are therefore flexible, bulging, and the (rolling-contact) contour of the annular component hence changing on the outer side of the latter.

Another advantageous embodiment with a view to simple and economical manufacture consists in that the bores are covered in a sealing manner on the outer side of the annular component by means of rubber diaphragms which are fastened, preferably being attached by adhesive bonding, by means of rubber bands or patches for instance. Attaching the rubber diaphragms by vulcanization could be considered here as an equivalent means of fastening, as could strapping the annular component tightly with wide and flat rubber bands.

Another advantageous embodiment consists in that the annular component is provided in the region of the rolling-contact contour with flexible inflation elements, the shape of which can be changed with the aid of a pressure medium that is introduced. These separate inflation elements can then be pumped up, with compressed air or pressurized oil for example, independently of the pressure in the working space, with the result that, once again, the rolling-contact contour on the outer side of the annular component changes. This opens up an additional possibility for intervention to control the spring characteristic.

Other features which are considered as characteristic for the invention are set forth in the appended claims.

Although the invention is illustrated and described herein as embodied in an air spring, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 a schematic diagram of a longitudinal section through an embodiment of the air spring according to the invention; and

FIG. 2 is an enlarged view of portion “A” of the air spring shown in FIG. 1.

### DETAILED DESCRIPTION OF THE INVENTION

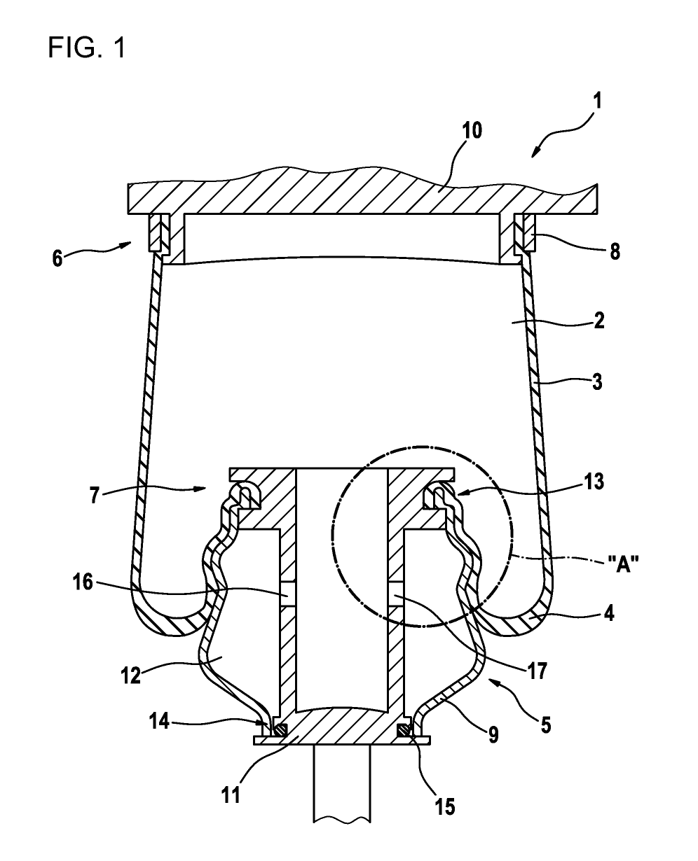

Referring now to the figures of the drawing in detail and first, particularly, to FIG. 1 thereof, there is shown an air spring 1 for vehicle running gear. The air spring is formed with a working space 2 that is filled with compressed air and that is delimited, at least in part, by an air sleeve or bellows 3.

At its bottom end, the bellows 3—which is also referred to as a rolling bellows, a roll bellows, an air sleeve, or an air bellows—rolls on the rolling-contact contour 5, forming a rolling fold 4 as it does so, and, at its ends 6 and 7, is fastened by way of deformable annular components 8 and 9 to the periphery of the connection parts, namely to the air spring cover 10, on the one hand, and to the air spring plunger 11, on the other hand.

At its lower end 7, the bellows 3 is thus fastened to the outer periphery of the air spring plunger 11 by way of the annular component 9, the annular component 9 having two axially spaced clamping regions 13 and 14, thereby forming an encircling cavity 12, and being designed on its outer side as a rolling-contact contour 5 for the bellows 3. The bellows 3 is thus fastened to the periphery of the air spring plunger 11 by way of one of the clamping regions, namely the upper clamping region 13.

The axially spaced clamping regions 13 and 14 are fastened in a sealing manner to the outer periphery of the air spring plunger 11 with the aid of an O-ring 15 and by appropriate clamping/pressing of the lower end 7 of the air spring bellows/bellows 3. The encircling cavity 12 is connected to the working space 2 via bores 16 and 17 formed in the peripheral wall of the air spring plunger 11.

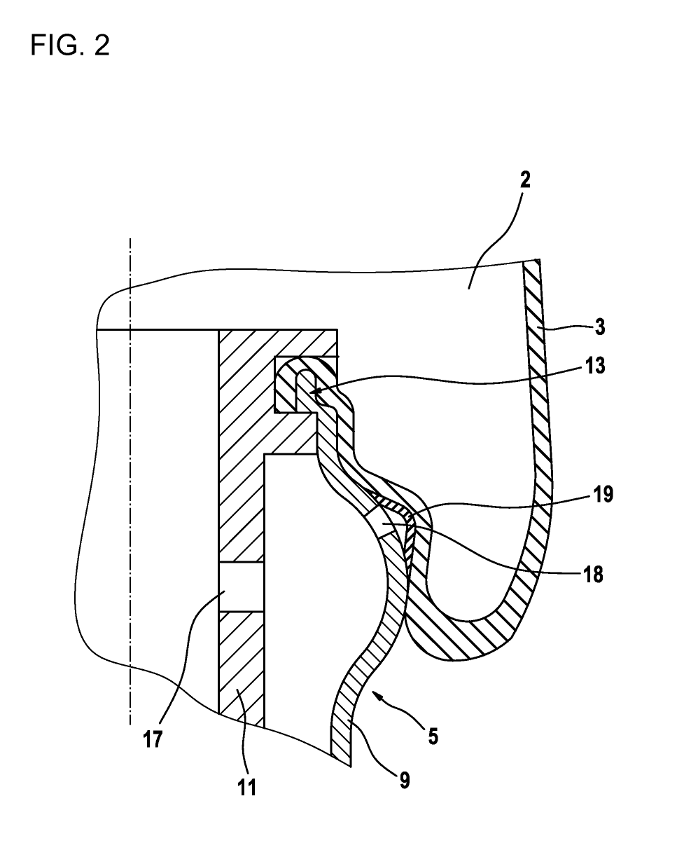

FIG. 2 shows an enlarged portion “A” of the air spring shown in FIG. 1. There, it can be seen that the annular component 9 is also provided in the region of the rolling-contact contour 5 with bores 18 which are sealingly covered on the outer side, i.e. on the rolling-contact contour 5, of the annular component 9, by way of rubber diaphragms 19 attached by vulcanization. The rolling-contact contour 5 then changes therefore as a function of the pressure in the working space by virtue of the fact that the rubber diaphragms bulge to a greater or lesser extent, depending on the pressure to which they are subjected.

1. An air spring for a vehicle chassis, comprising:
a rolling bellows attached to, and extending between, connecting parts, said rolling bellows enclosing at least one working space filled with compressed air;
said rolling bellows having ends connected, by way of deformable annular components, to respective peripheries of said connecting parts;
at least one of said annular components, at one end of said bellows, having a first end fastened at a first clamping region to an outer periphery of the associated said connection part and a second end fastened at a second clamping region, axially spaced apart from said first clamping region, and enclosing an encircling cavity;
said at least one annular component having an exterior rolling-contact contour, and said rolling bellows being fastened to a periphery of the associated said connection part by way of one of said first and second clamping regions; and
said rolling bellows being disposed to roll, at least partially, on said rolling-contact contour formed by said at least one annular component while forming at least one rolling fold.

2. The bellows according to claim 1, wherein said axially spaced-apart clamping regions are sealingly fastened to the outer periphery of the associated said connection part, and said encircling cavity is in communication with said working space.

3. The bellows according to claim 2, wherein said connection part is formed with one or more peripheral bores in a region of said annular component, for connecting said encircling cavity to said working space.

4. The bellows according to claim 1, wherein said annular component is formed, in a region of said rolling-contact contour, with bores and said bores are sealingly covered with flexible materials on an outer side of said annular component.

5. The bellows according to claim 4, wherein said bores are covered in a sealing manner on an outer side of said annular component by way of rubber diaphragms.

6. The bellows according to claim 5, wherein said diaphragms are attached by way of adhesive bonding to said rolling bellows.

7. The bellows according to claim 1, wherein said annular component is provided, in a region of said rolling-contact contour, with flexible inflation elements having a variable shape, and said shape is changeable by introducing a pressure medium.
